(19) United States
(12) Patent Application Publication
(10) Pub. No.: US 2015/0358515 A1
(43) Pub. Date: Dec. 10, 2015

(54) MOUNTING DEVICE, SYSTEM AND METHOD FOR HANDS FREE VIDEO AND IMAGE CAPTURING SYSTEM

(71) Applicant: CLIP A PHONE LLC, Middletown, CT (US)

(72) Inventors: DENNIS HOWARD RESNICK, Pine Plains, NY (US); CLIFF WHITE, JR., Middletown, CT (US)

(21) Appl. No.: 14/731,137

(22) Filed: Jun. 4, 2015

Related U.S. Application Data
(60) Provisional application No. 62/176,608, filed on Feb. 23, 2015.
(60) Provisional application No. 61/997,553, filed on Jun. 4, 2014.

(51) Int. Cl. H04N 5/225; A42B 1/00; A45F 5/02; H04N 5/232; G03B 17/56

(52) U.S. Cl. CPC H04N 5/2253; H04N 5/232; G03B 17/566; G03B 17/561; A45F 5/02; A42B 1/006

(57) ABSTRACT

A mounting device, system and method is provided for detachably coupling an electronic device to a surface. The device has a mating clip for vertically supporting the electronic device. The clip has a pair of resilient legs and a connecting portion, each leg having an inner surface having a plurality of jaws for detachably coupling to the surface. The clip includes an arm and platform for horizontally supporting the electronic device. The arm has a proximal end connected to the clip, and a distal end having a hook. The platform has an edge connected to the clip, and a surface having a hook. The clip includes a strap for securing the electronic device between the arm and platform. The strap has a first end connected to the hook of the arm and a second end connected to the hook of the platform.

### CROSS-REFERENCES TO RELATED APPLICATIONS

This application claims the benefit of provisional patent application 61/997,553 filed in the United States Patent and Trademark Office on Jun. 4, 2014 and provisional patent application 62/176,608 filed in the United States Patent and Trademark Office on Feb. 23, 2015, the entire disclosures of which are incorporated by reference herein.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE EFS-WEB

Not applicable.

### STATEMENT REGARDING PRIOR DISCLOSURES BY THE INVENTOR OR A JOINT INVENTOR

Not applicable.

### SEQUENCE LISTING

Not applicable.

### BACKGROUND OF THE INVENTION

1. Field of the Invention

This invention relates generally to mounting devices, and more particularly, to a mounting device, system and method for detachably coupling an electronic device to a brim of a hat to provide hands free video or image capturing with improved image stabilization.

2. Description of the Related Art

Keeping a camera or other electronic device steady is essential in order to avoid taking a blurry photo or video. Avoiding camera shake is particularly important when taking photos or videos at night or in low light situations. Users hold the device in their hands, which are naturally unsteady, and even the slightest movement, creates a blurry video or image. Even when using a mount or tripod to steady the device, shake can occur when you press the shutter button to take the photo or video. A variety of methods for triggering the shutter button and minimizing camera shake have been discovered using image stabilization techniques to reduce the blurring associated with the motion of the device.

One such method utilizes a user's head to stabilize the device, while using a wireless remote to trigger the shutter. This method naturally reduces camera shake to provide clearer photos and videos, and is attributed to the fact that a user's head is steadier and produces less jarring and bouncing. As such, it has become advantageous to design a mounting device capable of being worn on a user's head via a headband or other headpiece, which allows the user to trigger the shutter using a wireless remote shutter, volume controls, headphones, or a touch pad display screen.

Current attempts at designing camera and headpiece combinations have been largely unsuccessful in that they usually require special cameras or video cameras suitable for use connecting to the headpiece. Additionally these other attempts use mounts integrally coupled to unusual headpiece assemblies and not universally adaptable or easily removable devices combined with a favorite hat.

While these methods may be suitable for the particular purpose employed, or for general use, they would not be as suitable for the purposes of the present invention as disclosed hereafter.

It is, therefore, a primary object of the present invention to develop a new and improved mounting device, system and method for detachably coupling an electronic device to a brim of a hat to provide hands free video or image capturing with improved image stabilization.

It is another object of the present invention to provide a combination system capable of reducing camera shake by simply and easily attaching and detaching the electronic device to a brim of any hat.

It is another object of the present invention to provide a mounting device capable of receiving a variety of different electronic devices including, but not limited to, a camera, video camera, mobile device, mobile phone, tablet, or personal computing device.

It is another object of the present invention to provide a method which allows a user to trigger the shutter and take a photo or video, while the electronic device is coupled to a hat, using a touch screen display, volume controls, wireless remote control, Bluetooth shutter control, headphones, or buttons.

### BRIEF SUMMARY OF THE INVENTION

In accordance with one aspect of the present invention, a mounting system for coupling an electronic device to a surface is provided. The system includes means for supporting the electronic device in a vertical direction, wherein the vertical support means including means for detachably connecting to the surface. The system includes means for supporting the electronic device in a horizontal direction, wherein the horizontal support means including first and second spaced supports each having means for fastening. The system includes means for securing the electronic device to the vertical support means, between the first and second supports, wherein the securing means includes a first end and a second end, wherein the securing means removably and adjustable connects at the first end to the fastening means of the first support and at the second end to the fastening means of the second support.

The electronic device may be from the group consisting of a camera, video camera, mobile device, mobile phone, tablet, or personal computing device.

The surface may be a brim of a hat.

The vertical support means of the mounting system may be a mating clip having a pair of resilient legs and a portion for connecting the pair of legs together, each leg having a distal end, an outer surface, and an inner surface.

The connecting means of the vertical support means may include a plurality of jaws along the inner surface of each leg.

The first spaced support of the mounting system may be an arm having a proximal end connected to the outer surface of the mating clip and a distal end.

The fastening means of the first spaced support may be a hook integrally coupled to the distal end of the first support.

The second spaced support of the mounting system may be a platform having a surface and an edge connected to the outer surface of the mating clip.

The fastening means of the second spaced support may be a hook integrally coupled to the surface of the second support.

The securing means of the mounting system may be a strap having a first end connected to the hook of the arm and a second end connected to the hook of the platform.

In accordance with an additional embodiment, a mounting device for detachably coupling an electronic device to a surface is provided. The device includes a mating clip configured to provide a base for resting the electronic device in a vertical position. The clip has a pair of resilient legs and a portion for connecting the pair of legs together, each leg having a distal end, an outer surface, and an inner surface. The inner surface of each leg includes a plurality of jaws. The mounting surface is sandwiched between the legs of the clip and secured by the jaws. The device includes a support arm for supporting the weight of the electronic device in a horizontal direction. The arm has a proximal end connected to the outer surface of the mating clip and a distal end having a hook. The device has a support platform for supporting the weight of the electronic device in a horizontal direction. The platform has an edge connected to the outer surface of the mating clip, and a surface having a hook. The device includes a strap for securing the electronic device between the arm and the platform. The strap has a first end connected to the hook of the support arm and a second end connected to the hook of the support platform.

The electronic device of the mounting system may be from the group consisting of a camera, video camera, mobile device, mobile phone, tablet, or personal computing device.

The mounting surface may be a brim of a hat.

The support arm of the mounting device may include a pad positioned proximate the distal end.

In accordance with an additional embodiment, a combination hat and mounting system is provided. The hat of the system includes a brim extending outwardly from a frontal area. The system includes a mounting device for detachably coupling an electronic device to the brim of the hat. The mounting device includes a mating clip configured to provide a base for resting the electronic device in a vertical position. The clip has a pair of resilient legs and a portion for connecting the pair of legs together. Each leg has a distal end, an outer surface, and an inner surface. The inner surface of each leg includes a plurality of jaws. The brim is sandwiched between the legs of the clip and secured by the jaws. The mounting device includes a support arm for supporting the weight of the electronic device in a horizontal direction. The arm has a proximal end connected to the outer surface of the mating clip and a distal end having a hook. The mounting device includes a support platform for supporting the weight of the electronic device in a horizontal direction. The platform has an edge connected to the outer surface of the mating clip, and a surface having a hook. The mounting device includes a strap for securing the electronic device between the arm and the platform. The strap has a first end connected to the hook of the support arm and a second end connected to the hook of the support platform.

The electronic device may be from the group consisting of a camera, video camera, mobile device, mobile phone, tablet, or personal computing device.

In accordance with an additional embodiment a method for capturing a photo or video using the combination hat and mounting system is provided. The electronic device includes a lens and shutter. The steps include resting the electronic device in a vertical position on the mating clip between the support arm and the support platform. Next, securing the electronic device between the arm and platform, by fastening the first end of the strap to the hook of the arm. Then, passing the strap over the arm, electronic device and platform. Next, adjustably securing the second end of the strap to the hook of the platform. Then inserting the brim of the hat between the legs of the mating clip.

The method may further include the steps of turning the electronic device on, orientating the lens in a direction of a photograph to be taken, and triggering the shutter to take the photograph. The shutter may be triggered using touch screen display, volume controls, wireless remote control, Bluetooth shutter control, headphones, or buttons.

The method may further include the steps of turning the electronic device on, orientating the lens in a direction of a scene to be recorded, triggering the electronic device to begin recording the video, and triggering the electronic device to end recording the video. The shutter may be triggered using touch screen display, volume controls, wireless remote control, Bluetooth shutter control, headphones, or buttons.

### BRIEF DESCRIPTION OF THE SEVERAL VIEWS OF THE DRAWINGS

To these and to such other objects that may hereinafter appear, the present invention relates to mounting device, system and method for hands free video or image capturing as described in detail in the following specification and recited in the annexed claims, taken together with the accompanying drawings, in which like numerals refer to like parts in which:

FIG. 1 is an elevation view of the side of the mounting device in accordance with the preferred embodiment of the present invention;

FIG. 2 is a perspective view showing the rear and side of the mounting device of FIG. 1;

FIG. 3 is a perspective view showing the front and side of the mounting device of FIG. 1;

FIG. 4 is an elevation view showing the front of the mounting device of FIG. 1;

FIG. 5 is an elevation view showing the rear of the mounting device of FIG. 1;

FIG. 6 is a perspective view showing a strap for connecting an electronic device to the mounting device in accordance with the preferred embodiment of the present invention;

FIG. 7 is an elevation view showing the front of the strap of the mounting device;

FIG. 8 is a plan view showing the top of the strap of the mounting device;

FIG. 9 is an elevation view of the mounting device of FIG. 1 shown coupled to an electronic device, namely an iPhone (registered trademark of Apple) by a fastening means;

FIG. 10 is a perspective view of the mounting device of FIG. 2 shown coupled to the electronic device by the fastening means; and

FIG. 11 is a perspective view of the mounting device of FIG. 3 shown coupled to the electronic device by the fastening means and connected to a brim of a hat.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

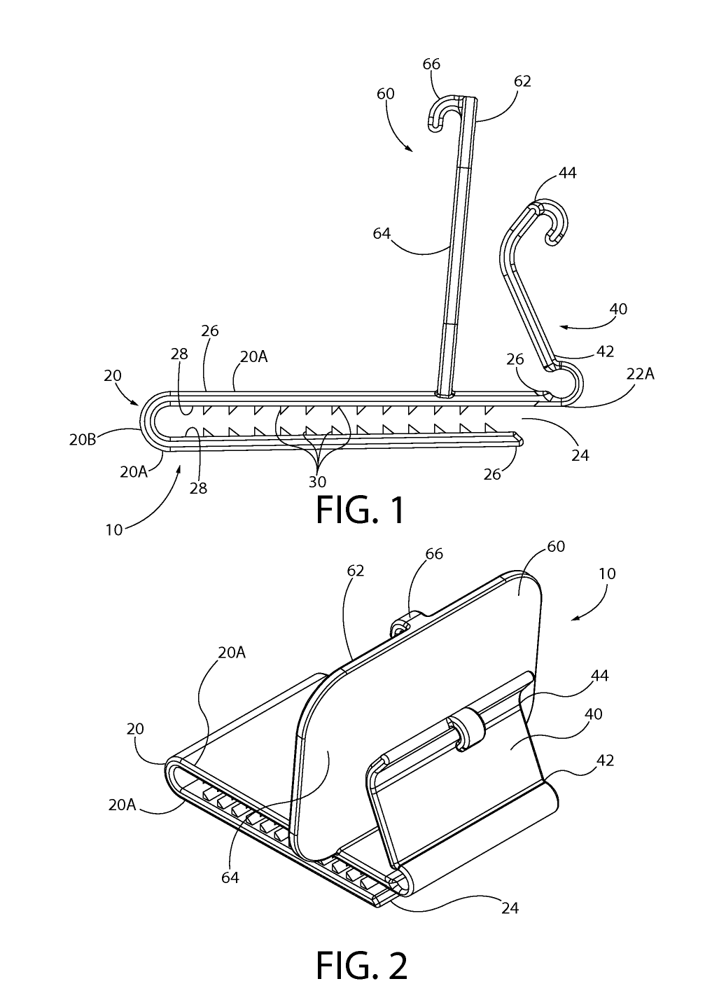

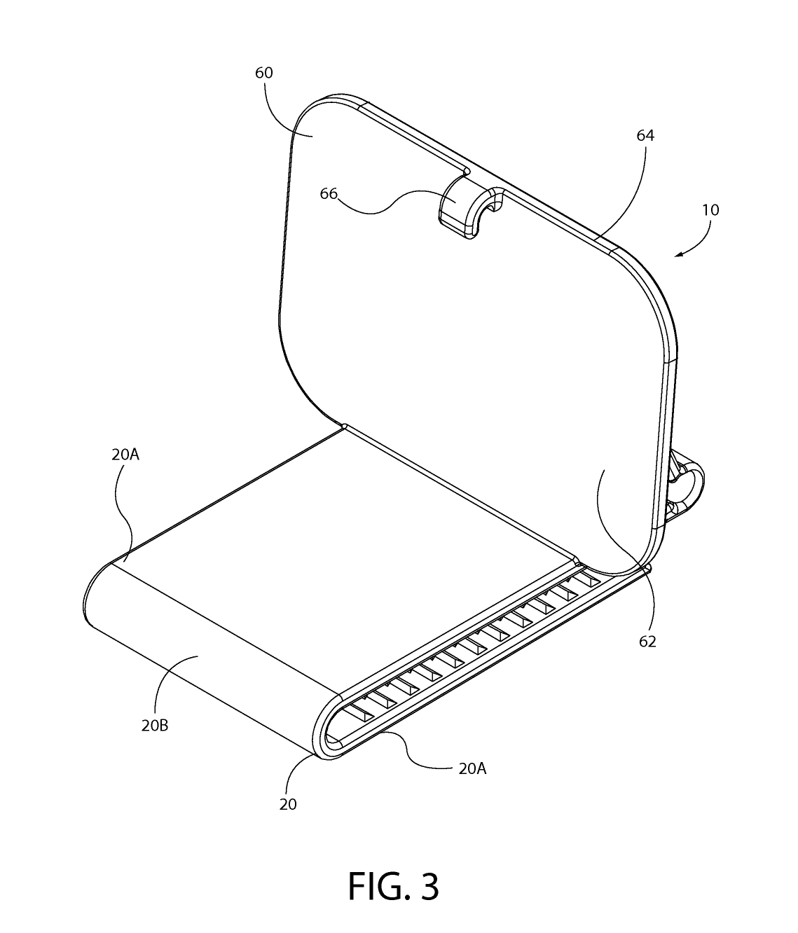

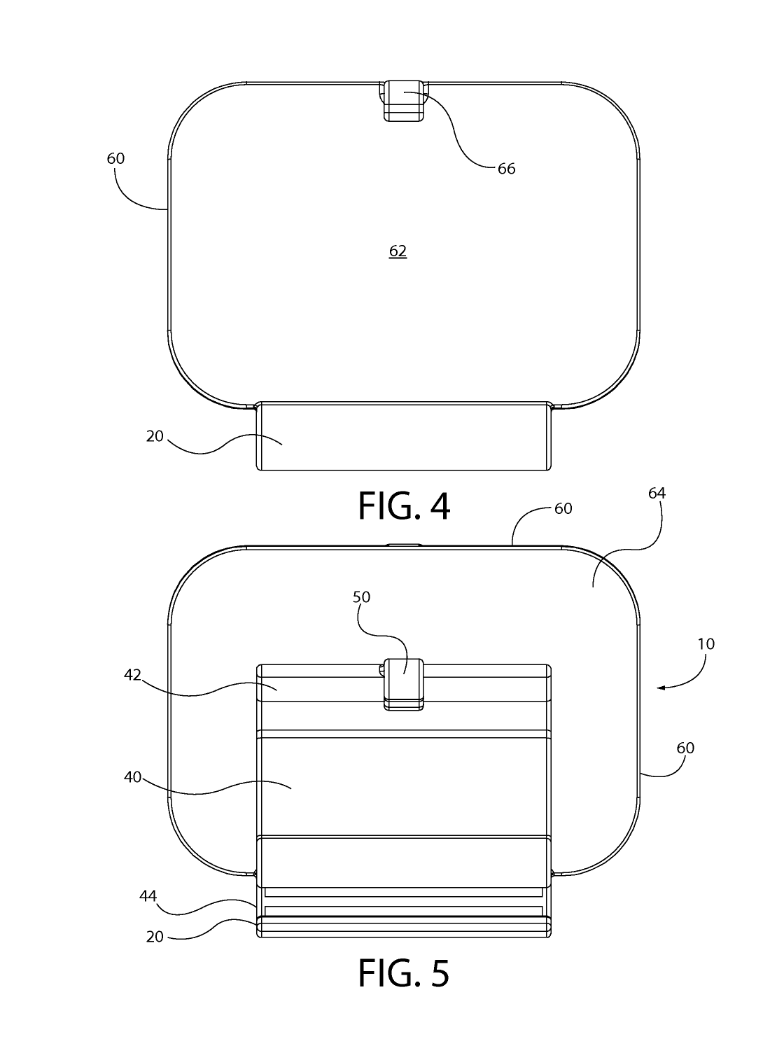

FIGS. 1-5 illustrate the mounting device 10 of the preferred embodiment of the present invention for providing hands free video or image capturing. In its broadest context, the mounting device 10 detachable couples an electronic device to a mountable surface and includes a mating clip 20, having an integrally coupled support plate 60 and support arm 40. The mating clip 20 is securable to the mountable surface, while the support arm 40 and plate 60 secures the electronic device thereto.

For purposes of illustration, the present invention will discuss the mounting device 10 in terms of receiving, supporting and securing the electronic device thereto, and more particularly, an electronic device shown and illustrated as a mobile phone 12. Other electronic devices such as personal electronic devices, cameras, video cameras, tablets, and computers are contemplated.

For purposes of illustration, the present invention will refer to the mountable device as being removable coupled to a mountable surface 100, namely a brim 104 of a hat 102. A variety of mounting surfaces are contemplated, such as shelves, walls, furniture, and other objects and items and therefore the mountable surface 100 is not limited to a hat.

In the preferred embodiment, the hat 102 may be a baseball style cap, or other similar cap or visor, having a crown 106 having a frontal area 110, wherein the brim 104 extends outward from the frontal area 110. Preferably, the brim 106 includes a plastic or cardboard stiffener 108 covered by a fabric material.

The mounting device 10 includes the mating clip 20 configured to mate with the brim 104 of the hat 102. The mating clip 20 is a resiliently deformable U-shaped member, comprised of two legs 20A connected to each other by a portion 20B. Each leg 20A includes a distal gripping end 22. An opening 24 is interspaced between the legs 20A. The opening 24 is sized to allow the brim of the hat, or other mountable surface, to be received therein. The legs 20A includes an outer surface 26 and an inner surface 28, wherein the inner surface 28 includes a plurality of jaws 30 extending inwardly from the gripping ends 22.

The support arm 40 has a distal end 42 and a proximal end 44. At the proximal end 44 the arm is integrally connected to the mating clip near the first gripping end 22A. The arm 40 extends substantially away from the mating clip toward the distal end 42. The arm includes a first surface 46, which may include a gripping felt pad 48, wherein the first surface 46 is configured to support the weight of the mobile phone 12. The distal end 42 includes a hook 50.

The support platform 60 is a substantially rectangular plate extending vertically from the mating clip 20. The platform is perpendicularly connected at a first edge 63 to the outer surface 26 of the clip 20 approximate the arm 40, such that the platform 60 and arm 40 form an opening for accepting the mobile phone 12 therebetween. The platform 60 has a front surface 62 and a back surface 64, wherein the back surface 64 supports the mobile phone 12 thereagainst. The platform has a hook 66 extending from the back surface 64.

The support arm 40 and platform 60 may be adjustably positioned at predetermined angles from the clip 20 in order capture video and images, preferably at the user's angle of vision, when mounted to the hat 102.

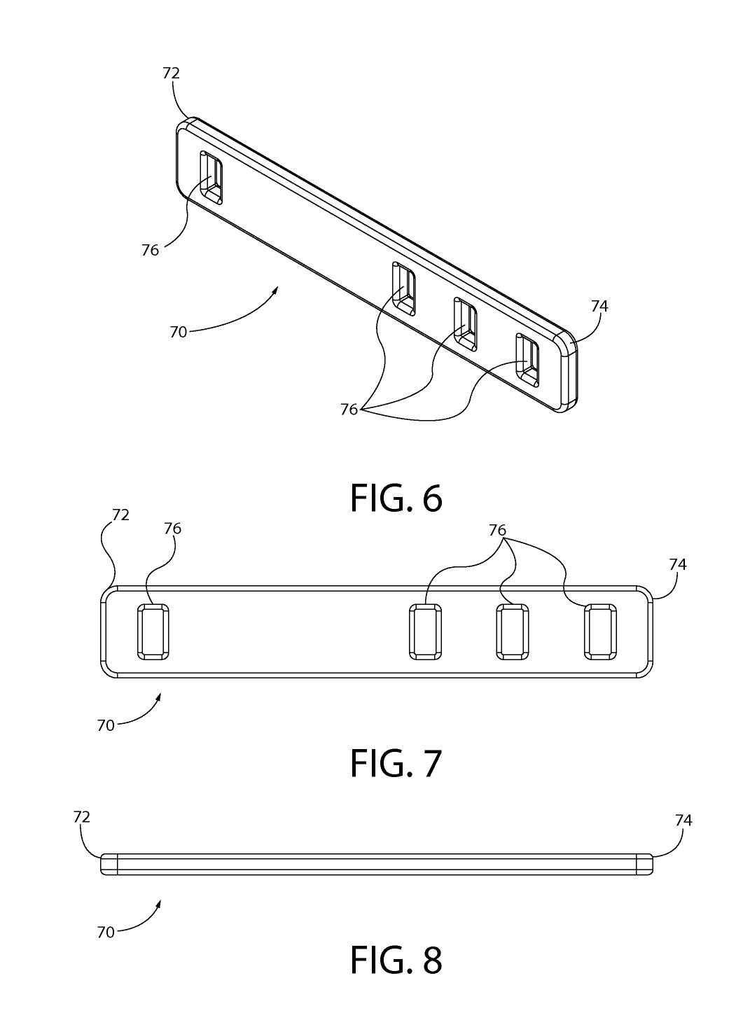

A fastening means 70 is used to secure the mobile phone 12 to the mating clip 20 between the platform 60 and arm 40. Preferably, the fastening means 70 is a substantially elongated rectangular strap illustrated in FIGS. 6-8. The strap 70 is preferably made out of rubber or plastic and is capable of bending and stretch. The strap 70 has a first end 72 and a second end 74, and a plurality of spaced openings 76. The openings 76 are configured to loop onto the hooks 50, 66 of the arm 40 and platform 60 respectively. The openings 76 of the strap 70 are configured and spaced to adjustably secure a variety of differently sized devices to the clip 20.

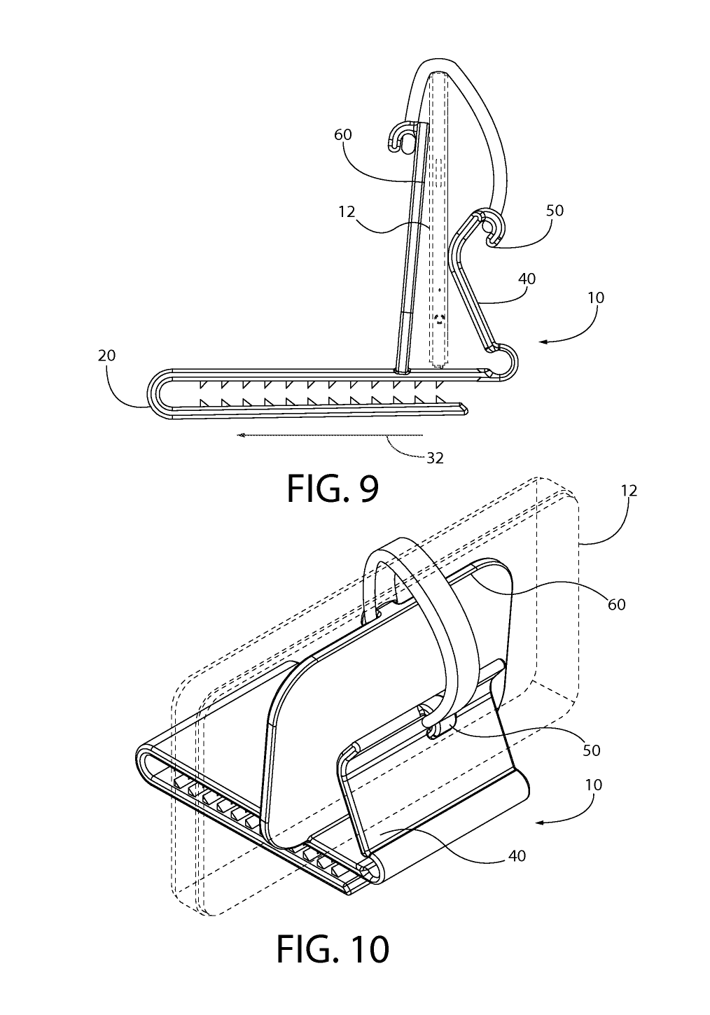

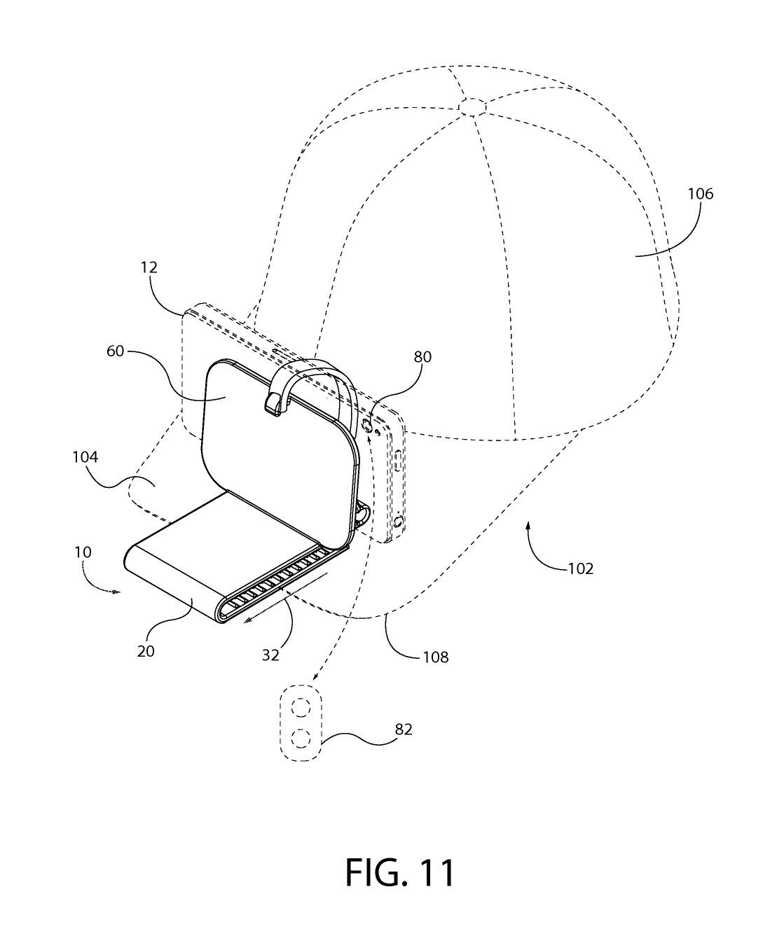

FIGS. 9-11 illustrate the device 10 in use. To couple the mobile phone 12 to the mounting device 10, a user inserts the mobile phone 12 between the support arm 40 and the support platform 60. The mobile phone 12 is orientated such that the shutter is outwardly facing for taking a photo or video in front of the user's head. If the hat is worn backwards on the head of the user, the electronic device is similarly orientated, however, the image or video captured would be behind the user's head. The user couples the opening 76 at first end 72 of the strap 70 to the hook 50 of the arm 40. Next, the user pulls the strap over the mobile phone 12 platform 60 and secures the appropriate opening 76 at second end 74 of the strap 70 to the hook 66. Then, the user turns on the video or camera feature of the mobile phone 12.

To mount the device 10 on the hat 102, the user places the gripping ends 22 of the mating clip 12 adjacent the brim 104 of the hat 102 and inserts the brim 104 of the hat in the opening 24 as shown by arrow 32. The jaws 30 of the clip 20 secure the mounting device 10 to the brim 104 and prohibit the device 10 from easily sliding off or moving.

Once secured to the brim 104 of the hat 102, the mobile phone 12 is ready for use capturing video or images. In the preferred embodiment, the mobile phone or other electronic device 12 includes a lens 81 and shutter trigger or controller 80, which may be a Bluetooth (registered trademark of Bluetooth Special Interest Group, Inc.) or other wireless shutter controller in communication with a Bluetooth or other wireless remote controller 82. The wireless shutter control is typically comprised of a transmitter and a receiver. The receiver is connected to a shutter release socket of the electronic device 12. The wireless transmitter may be arranged on the remote controller 82. The remote controller 82 is provided with buttons. When the corresponding button is pressed, the wireless transmitter transmits a signal. The receiver connected to the electronic device, after receiving an instruction from the transmitter, transmits a shutter release signal to the electronic device control system. The control system immediately performs the intended function, which may include focusing and picture pickup upon receiving the signal, long-time exposure, delayed exposure, time lapse exposure, video recording and/or time lapse functions.

In alternate embodiments, the user, via Bluetooth remote shutter, volume controls, headphones, or a touch pad display screen, may trigger the shutter button.

It should be understood that numerous variations are possible, while adhering to the inventive concept. Such variations are contemplated as being a part of the present invention.

While only one preferred embodiment of the present invention has been disclosed for purposes of illustration, it is obvious that many modifications and variations could be made thereto. It is intended to cover all of those modifications and variations, which fall within the scope of the present invention as defined by the following claims.

We claim:

1. A mounting system for coupling an electronic device to a surface, comprising:
means for supporting the electronic device in a vertical direction, wherein said vertical support means including means for detachably connecting to said surface;
means for supporting the electronic device in a horizontal direction, wherein said horizontal support means including first and second spaced supports each having means for fastening; and
means for securing said electronic device to said vertical support means, between said first and second supports, wherein said securing means includes a first end and a second end, wherein said securing means removably and adjustable connects at said first end to said fastening means of said first support and at said second end to said fastening means of said second support.

2. The mounting system of claim 1 wherein the electronic device is from the group consisting of a camera, video camera, mobile device, mobile phone, tablet, or personal computing device.

3. The mounting system of claim 1 wherein the surface is a brim of a hat.

4. The mounting system of claim 1 wherein the vertical support means is a mating clip having a pair of resilient legs and a portion for connecting the pair of legs together, each leg having a distal end, an outer surface, and an inner surface.

5. The mounting system of claim 4 wherein the connecting means of the vertical support means includes a plurality of jaws along the inner surface of each leg.

6. The mounting system of claim 4 wherein the first spaced support is an arm having a proximal end connected to the outer surface of the mating clip and a distal end.

7. The mounting system of claim 6 wherein the fastening means of the first spaced support is a hook integrally coupled to the distal end of the first support.

8. The mounting system of claim 7 wherein the second spaced support is a platform having a surface and an edge connected to the outer surface of the mating clip.

9. The mounting system of claim 8 wherein the fastening means of the second spaced support is a hook integrally coupled to the surface of the second support.

10. The mounting system of claim 9 wherein the securing means is a strap having a first end connected to the hook of the arm and a second end connected to the hook of the platform.

11. A mounting device for detachably coupling an electronic device to a surface, comprising:
a mating clip configured to provide a base for resting said electronic device in a vertical position, said clip having a pair of resilient legs and a portion for connecting said pair of legs together, each leg having a distal end, an outer surface, and an inner surface, wherein said inner surface of each leg includes a plurality of jaws, wherein the mounting surface is sandwiched between said legs of said clip and secured by said jaws;
a support arm for supporting the weight of the electronic device in a horizontal direction, said arm having a proximal end connected to said outer surface of said mating clip and a distal end having a hook;
a support platform for supporting the weight of the electronic device in a horizontal direction, said platform having an edge connected to said outer surface of said mating clip, and a surface having a hook; and
a strap for securing said electronic device between said arm and said platform, said strap having a first end connected to said hook of said support arm and a second end connected to said hook of said support platform.

12. The mounting system of claim 11 wherein the electronic device is from the group consisting of a camera, video camera, mobile device, mobile phone, tablet, or personal computing device.

13. The mounting device of claim 11 wherein the mounting surface is a brim of a hat.

14. The mounting device of claim 11 wherein the support arm includes a pad positioned proximate the distal end.

15. A combination hat and mounting system, comprising:
a brim extending outwardly from a frontal area of said hat; and
a mounting device for detachably coupling an electronic device to said brim of said hat, said mounting device comprising:
a mating clip configured to provide a base for resting said electronic device in a vertical position, said clip having a pair of resilient legs and a portion for connecting said pair of legs together, each leg having a distal end, an outer surface, and an inner surface, wherein said inner surface of each leg includes a plurality of jaws, wherein said brim is sandwiched between said legs of said clip and secured by said jaws;
a support arm for supporting the weight of the electronic device in a horizontal direction, said arm having a proximal end connected to said outer surface of said mating clip and a distal end having a hook;
a support platform for supporting the weight of the electronic device in a horizontal direction, said platform having an edge connected to said outer surface of said mating clip, and a surface having a hook; and
a strap for securing said electronic device between said arm and said platform, said strap having a first end connected to said hook of said support arm and a second end connected to said hook of said support platform.

16. The mounting system of claim 11 wherein the electronic device is from the group consisting of a camera, video camera, mobile device, mobile phone, tablet, or personal computing device.

17. A method for capturing a photo or video using the combination hat and mounting system of claim 15, wherein the electronic device includes a lens and shutter, the steps comprising:
i. resting the electronic device in a vertical position on the mating clip between the support arm and the support platform;
ii. securing the electronic device between the arm and platform, by fastening the first end of the strap to the hook of the arm;
iii. passing the strap over the arm, electronic device and platform;
iv. adjustably securing the second end of the strap to the hook of the platform; and
v. inserting the brim of the hat between the legs of the mating clip.

18. The method of claim 17 further comprising the steps of:
i. turning the electronic device on;
ii. orientating the lens in a direction of a photograph to be taken; and
iii. triggering the shutter to take the photograph.

19. The method of claim 18 wherein the shutter is triggered using touch screen display, volume controls, wireless remote control, Bluetooth shutter control, headphones, or buttons.

20. The method of claim 17 further comprising the steps of:
i. turning the electronic device on;
ii. orientating the lens in a direction of a scene to be recorded;
iii. triggering the electronic device to begin recording the video; and
iv. triggering the electronic device to end recording the video.

21. The method of claim 20 wherein the shutter is triggered using touch screen display, volume controls, wireless remote control, Bluetooth shutter control, headphones, or buttons.
